(19) United States
(12) Patent Application Publication
(10) Pub. No.: US 2018/0062164 A1
(43) Pub. Date: Mar. 1, 2018

(54) ACRYLONITRILE-BASED FIBER FOR ELECTRODES, ELECTRODE CONTAINING THE FIBER, AND LEAD-ACID BATTERY HAVING THE ELECTRODE

(71) Applicant: JAPAN EXLAN COMPANY LIMITED, Osaka (JP)

(72) Inventors: Osamu YAMASHITA, Osaka (JP); Katsuji SAKAGUCHI, Osaka (JP)

(73) Assignee: JAPAN EXLAN COMPANY LIMITED, Osaka (JP)

(21) Appl. No.: 15/557,973

(22) PCT Filed: Mar. 25, 2016
(86) PCT No.: PCT/JP2016/059630

§ 371 Date: Sep. 13, 2017

(30) Foreign Application Priority Data
Mar. 27, 2015 (JP) 2015-066786

(51) Int. Cl. H01M 4/14; H01M 4/62; C08F 20/56

(52) U.S. Cl. CPC H01M 4/14; C08F 20/56; H01M 4/622

(57) ABSTRACT

According to the present invention, there is provided an acrylonitrile-based fiber for electrodes which contains a hydrophilic ingredient in an inner area of the fiber and has a volume resistivity of not more than 1×10⁹ Ω·cm.

### TECHNICAL FIELD OF THE INVENTION

The present invention relates to an acrylonitrile-based fiber for electrodes which is excellent in an acid-resisting property and also to an electrode containing the fiber as well as to a lead-acid battery having the electrode.

### BACKGROUND ART

Since a lead-acid battery has a characteristic that it is less expensive and is highly reliable, it has been widely used as a battery for automobiles, as a power source for electrically driven vehicles such as a golf cart and further as a battery for industrial equipments such as an uninterruptible power supply. Usually, an electrode for lead-acid battery is constituted by forming a pasty active substance layer on a collector. In the electrode for lead-acid battery of this type, a short fiber for reinforcement in 1 to 10 mm length is contained in the pasty active substance layer in a dispersed manner so as to prevent a detachment of the active substance.

Patent Document 1 discloses that, by using, as the short fiber for reinforcement, a fiber wherein a monomer having a hydrophilic group is subjected to a graft copolymerization on a surface of a thermoplastic synthetic resin, an utilization efficiency of the active substance is improved whereby a capacity of the battery is enhanced. In this method, although the enhancement of the battery capacity is achieved in an initial stage, there is a problem that a hydrophilic polymer layer is predominantly decomposed with an elapse of time as a result of its contact with an acid whereby the battery capacity is lowered. Accordingly, this method is not practical.

### PRIOR ART DOCUMENTS

### Patent Documents

Patent Document 1: Japanese Patent Application Laid-Open (JP-A) No. 241773/98

### DISCLOSURE OF THE INVENTION

### Problem that the Invention is to Solve

The present invention has been achieved in view of the above-mentioned conventional problems. An object of the present invention is to provide an acrylonitrile-based fiber for electrodes which is excellent in an acid-resisting property and is less affected by a decomposition even in a use for a long time, and also to provide an electrode containing the fiber as well as a lead-acid battery having the electrode.

### Means for Solving the Problem

The above object of the present invention is achieved by the following means.

(1) An acrylonitrile-based fiber for electrodes which contains a hydrophilic ingredient in an inner area of the fiber and has a volume resistivity of not more than 1×10⁹ Ω·cm.

(2) The acrylonitrile-based fiber for electrodes according to (1), wherein its aspect ratio is not less than 1 and less than 250.

(3) The acrylonitrile-based fiber for electrodes according to (1) or (2), wherein the hydrophilic ingredient is a polymer containing, as a constituting unit, 30 to 90% by weight of a monomer represented by the following formula.

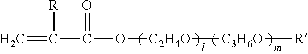

(In the formula, R is hydrogen atom or lower alkyl group; R′ is hydrogen atom, alkyl group having 18 or less carbon(s), phenyl group or a derivative thereof; 15<I<50; and 0≦m<I.)

(4) The acrylonitrile-based fiber for electrodes according to any of (1) to (3), wherein the hydrophilic ingredient is a polymer containing, as a constituting unit, 10 to 70% by weight of acrylonitrile.

(5) An electrode containing the fiber according to any of (1) to (4).

(6) A lead-acid battery having the electrode according to (5).

### Advantages of the Invention

Since the acrylonitrile-based fiber for electrodes according to the present invention has an acrylonitrile-based polymer as a main ingredient, its acid-resisting property as a base material is high. In addition, a hydrophilic ingredient is contained in an inner area of the fiber and, as a result, it is possible to suppress a decomposition of the hydrophilic ingredient and an elution thereof due to an electrolyte. In a lead-acid battery having an electrode in which the fiber of the present invention as such is contained, a wetting ability of the electrode is now improved, the electrolyte is apt to permeate therein, and even the active substance in an inner area of the electrode can be efficiently utilized. As a result, a capacity of the battery is enhanced. Moreover, since the hydrophilic ingredient is hardly decomposed and eluted, the capacity of the battery hardly lowers even in a repeated use for a long period.

### BEST MODE FOR CARRYING OUT THE INVENTION

Hereinafter, embodiments of the present invention will be illustrated in detail. The acrylonitrile-based fiber of the present invention is a fiber containing an acrylonitrile-based polymer as a main ingredient and is a fiber containing a hydrophilic ingredient at least in an inner area of the fiber. Here, the acrylonitrile-based polymer may be such a one which is used for producing conventionally known acrylic fibers or acrylic-based fibers. It is preferred that the acrylonitrile-based polymer contains 80% by weight or, more preferably, 88% by weight or more of acrylonitrile as a constituting ingredient. Incidentally, it goes without saying that, in the acrylonitrile-based fiber for electrodes according to the present invention, the hydrophilic ingredient may also be present on a surface of the fiber so far as the hydrophilic ingredient is contained in the inner area of the fiber.

Further, with regard to a monomer which is capable of being copolymerized with acrylonitrile in the acrylonitrile-based polymer, any vinyl compound may be used. Representative examples thereof are: acrylic acid, methacrylic acid or esters thereof; acrylamide, methacrylamide or N-alkyl substituted products thereof; vinyl esters such as vinyl acetate; vinyl or vinylidene halides such as vinyl chloride, vinyl bromide and vinylidene chloride; and unsaturated sulfonic acids such as vinylsulfonic acid, allylsulfonic acid, methallylsulfonic acid and p-styrenesulfonic acid or salts thereof. Incidentally, as to the above acrylonitrile-based polymer, plural species thereof may be also used as the constituting ingredients so far as they satisfy the above composition.

There is no particular limitation for a method of synthesizing the acrylonitrile-based polymer, and well-known polymerization means such as a suspension polymerization method, an emulsion polymerization method and a solution polymerization method may be used.

There is no particular limitation for a hydrophilic ingredient which is adoptable in the present invention so far as it is capable of enhancing a hydrophilicity by being contained in the acrylonitrile-based fiber. As to an organic material, there may be exemplified organic polymer compounds having a hydrophilic side chain such as polyalkylene oxide chain, polyether amide chain and polyether ester chain and a hydrophilic functional group such as carboxyl group. As to an inorganic material, it is also possible to use particles of metal oxide such as titanium oxide and tin oxide and fine particles of carbonaceous substance such as carbon black and graphite having a hydrophilic group such as hydroxyl group or carboxyl group.

As to a particularly useful one among the hydrophilic ingredient as such, there may be exemplified an acrylonitrile-based hydrophilic resin which is produced by a method wherein a vinyl monomer having the above-mentioned hydrophilic side chain is copolymerized with acrylonitrile (hereinafter, it will be referred to as the method [1]) or is produced by a method wherein a vinyl monomer having a reactive functional group is copolymerized with acrylonitrile followed by subjecting to graft reaction with a reactive compound having a hydrophilic functional group (hereinafter, it will be referred to as the method [2]).

It is preferred that the acrylonitrile-based hydrophilic resin as such contains 10 to 70% by weight, more preferred 15 to 50% by weight, and further preferred 15 to 30% by weight of acrylonitrile by means of bonding. When a content of acrylonitrile is within a range of 10 to 70% by weight, there is achieved an affinity to some extent for the above acrylonitrile-based polymer. Thus, when the content is less than the lower limit of the range, the affinity for the acrylonitrile-based polymer may become too low and yarn breakage may frequently happen in a spinning step whereby an operability may become bad. When the content is more than the upper limit of the range, a hydrophilic property may not be sufficiently achieved.

In the above method [1], it is preferred, in view of more enhancing the affinity of the resulting hydrophilic resin for the acrylonitrile-based polymer, that a monomer represented by the above formula is used as a vinyl monomer having a hydrophilic side chain. The binding amount of the monomer is preferred to be 30 to 90% by weight, more preferred to be 50 to 85% by weight, and further preferred to be 70 to 85% by weight to the weight of the resulting copolymer. The lower alkyl group in the above formula stands for such a one wherein carbon number is usually 5 or less and, practically, 3 or less. In the copolymerization with acrylonitrile, other vinyl compound may also be copolymerized in addition to the above vinyl monomer.

Preferred examples of the vinyl monomer having a hydrophilic side chain are a reaction product of 2-methacryloyloxyethyl isocyanate with polyethylene glycol monomethyl ether, etc. Preferred examples of the monomer shown by the above formula are methoxypolyethylene glycol (30 mol) methacrylate, methoxy-polyethylene glycol (30 mol) acrylate, polyethylene glycol-2,4,6-tris-1-phenylethylphenyl ether methacrylate (number average molecular weight: ca. 1600), etc.

Preferred examples of the vinyl monomer having a reactive functional group to be used in the above method [2] are 2-hydroxyethyl methacrylate, acrylic acid, methacrylic acid, N-hydroxymethylacrylamide, N,N-dimethylaminoethyl methacrylate, glycidyl methacrylate, 2-methacryloyloxyethyl isocyanate, etc. Preferred examples of the reactive compound having a hydrophilic group are polyethylene glycol monomethyl ether, polyethylene glycol monomethacrylate, etc.

It is preferred that the acrylonitrile-based hydrophilic resin of the present invention exhibits a degree of swelling in water of as low as possible. Further, its upper limit is preferred to be 300 g/g or less and more preferred to be 150 g/g or less. When it is more than 300 g/g, troubles such as yarn breakage are apt to happen in a spinning step. Various methods maybe used for adjusting the degree of swelling in water. Examples thereof are to copolymerize a cross-linkable monomer, to modify the size of 1 or m of the monomer shown in the above formula, etc.

In addition, although the acrylonitrile-based hydrophilic resin may be soluble in water and in a solvent for an acrylonitrile-based polymer, it is preferred to have such a property that the resin is insoluble in water and in the solvent for the acrylonitrile-based polymer and further that the resin is stably dispersed in the solvent. The fact that it is insoluble in water and in the solvent for the acrylonitrile-based polymer means that an elution of the acrylonitrile-based hydrophilic resin from the fiber in a spinning step is suppressed thereby. As a result, it is now possible to impart a volume resistivity within a range which will be mentioned later to the finally-prepared acrylonitrile-based fiber. In addition, the stable dispersion suppresses troubles such as clogging of nozzle and yarn breakage in the spinning step. As a result, it contributes to a stable spinning.

As to a method for synthesizing the above acrylonitrile-based hydrophilic resin, well-known polymerization means may be adopted similar to the case of an acrylonitrile-based polymer. In some cases, a graft reaction may be also utilized for introducing a hydrophilic ingredient as mentioned above.

Now a method for producing an acrylonitrile-based fiber of the present invention will be mentioned. Although it is desirable that the acrylonitrile-based fiber of the present invention has such a structure wherein a hydrophilic ingredient is dispersed in an acrylonitrile-based polymer in an inner area of the fiber, it may be also acceptable that there is an exposed part on a surface of the fiber. As a result of adopting the structure as such, a decomposition and elution of the hydrophilic ingredient are suppressed even when exposed to an electrolyte whereby an acid-resisting property is enhanced.

It is also desirable in the acrylonitrile-based fiber for electrodes according to the present invention that a volume resistivity upon measurement under conditions which will be mentioned below is preferably 1×10⁹ Ω·cm or less and more preferably 1×10⁸ Ω·cm or less, so as to increase a wetting ability of an inner area of electrode upon being contained in the electrode or so as to facilitate a mobility of an ion in the inner area of the electrode. Since there is a risk of causing an overheat due to too much current if the volume resistivity is too low, the lower limit is preferred to be 1 Ω·cm or more, and more preferred to be 1×10³ Ω·cm or more. As to a method for adjusting a value of the volume resistivity within the above range, there may be exemplified a method wherein a rate of the polymer in the acrylonitrile-based fiber is preferably adjusted to an extent of 80 to 99% by weight of the acrylonitrile-based polymer and 1 to 20% by weight of the hydrophilic ingredient, and more preferably adjusted to an extent of 95 to 99% by weight of the acrylonitrile-based polymer and 1 to 5% by weight of the hydrophilic ingredient.

As to a method for producing the acrylonitrile-based fiber of the present invention, there may be exemplified a method wherein a hydrophilic ingredient is mixed with a solution prepared by dissolving an acrylonitrile-based polymer in a solvent and the resulting spinning dope is spun to give the fiber. Although it is possible that, after conducting steps of spinning, coagulation, washing with water and drawing, the fiber is cut into an appropriate length without drying and is utilized for preparing an electrode, it is also acceptable that the fiber is dried and then cut or pulverized, and is utilized for preparing the electrode.

As to a solvent for dissolving the acrylonitrile-based polymer thereinto, there may be exemplified an organic solvent such as dimethylformamide, dimethylacetamide or dimethyl sulfoxide and an inorganic solvent such as nitric acid, an aqueous solution of zinc chloride or an aqueous solution of sodium thiocyanate.

As to a fineness of the acrylonitrile-based fiber adopted by the present invention, it is preferred to be 0.1 to 10 dtex and more preferred to be 0.5 to 5 dtex. When the fineness is less than 0.1 dtex, there is a possibility that a production cost for the fiber becomes high or the fiber is apt to become granular lumps upon preparing a paste for an electrode. When the fineness is more than 10 dtex, there is a possibility that an effect of enhancing a wetting ability of an inner area of an electrode is hardly achieved since a surface area of the fiber per unit weight becomes small.

In the acrylonitrile-based fiber of the present invention, a lower limit of an aspect ratio of the fiber (which is calculated by means of dividing a fiber length by a fiber diameter) is preferred to be 1 or more and more preferred to be 5 or more when a property of a cutter and a cost for cutting are taken into consideration. As to an upper limit thereof, it is preferred to be 250 or less and more preferred to be 200 or less, in view of the fact that the fiber is apt to become granular lumps in the kneading upon preparation of a lead paste.

The acrylonitrile-based fiber prepared as mentioned above has such a structure that a hydrophilic ingredient is dispersed in an inner area of the fiber and has such a characteristic property that a volume resistivity is preferred to be 1 Ω·cm or more and more preferred to be 1×10³ Ω·cm or more, and preferred to be 1×10⁹ Ω·cm or less, and more preferred to be 1×10⁸ Ω·cm or less. Further, such a structure can also maintain a mechanical strength of the fiber.

Since the acrylonitrile-based fiber of the present invention having the above-mentioned structure can achieve 5% by weight or less, preferably 2% by weight or less of a weight decreasing rate in an acid resistance test, it is now possible to maintain a durability of a battery property upon adding to an electrode and to contribute to an enhancement of the battery property.

When the above-mentioned acrylonitrile-based fiber for electrodes in accordance with the present invention is utilized by dispersing into an active substance layer upon preparing the electrode, a wetting ability of an inner area of the electrode is improved and an utilizing efficiency of the active substance is enhanced whereby an improvement in a battery capacity can be expected. Moreover, since the fiber is excellent in an acid-resisting property, it is expected that a deterioration in a property becomes small even in a use for a long time when used as an electrode for a lead-acid battery, etc.

To be more specific, it is now possible to prepare an electrode by utilizing a conventionally known method for preparing an electrode for battery and by adding the acrylonitrile-based fiber for electrodes according to the present invention in an amount of preferably 0.05 to 2% by weight and more preferably 0.1 to 1% by weight to the weight of the active substance. Since the electrode is excellent in the acid-resisting property as mentioned already, it can be advantageously used for a lead-acid battery which uses sulfuric acid as an electrolyte.

### EXAMPLES

The present invention will now be more specifically illustrated hereinafter by way of Examples although the scope of the present invention shall not be limited thereby. Unless otherwise mentioned, the terms part(s) and percentage in Examples are on the basis of weight. Incidentally, a volume resistivity of a fiber, a weight reduction percentage in an acid resistance test, a degree of swelling in water, an amount of carboxyl group, a sucked-up length of diluted sulfuric acid and a preparation of a lead paste mentioned in Examples were measured by the following methods.

(1) Measurement of Volume Resistivity:

A fineness T (tex) and specific gravity (d) of a fiber are previously measured by conventional methods. After that, the fiber is subjected to a scoring treatment at 60° C. for 30 minutes in a 0.1% aqueous solution of Neugen HC (manufactured by Daiichi Kogyo Seiyaku) with a bath ratio of 1:100, washed with running water and dried at 70° C. for 1 hour. The fiber is cut into a length of about 6 to 7 cm and allowed to stand in an atmosphere of 20° C. and 65% relative humidity for not shorter than 3 hours. Resulting fibers (filaments) are made into a bundle which is composed of five fibers. An electroconductive adhesive is applied to one end of the fiber bundle to an extent of about 5 mm. Under a state wherein a load of 900 mg/tex is applied to this fiber bundle, the above electroconductive adhesive is applied to a position which is about 5 cm far from a position to which the electroconductive adhesive was applied (a distance between the electroconductive adhesives applied at that time is defined as L (cm)) to prepare a measurement sample. Then, electrodes are connected to the areas to which the electroconductive adhesive is applied under a state wherein the load of 900 mg/tex is applied to the measurement sample. A resistance (R) upon an application of a direct current of 500 V is measured using a High RESISTANCE METER 4329A (manufactured by Yokogawa Hewlett-Packard). The volume resistivity is calculated by the following formula.

Volume resistivity(Ω·cm)=(R×T×10⁻⁵)/(L×d)

(2) Measurement of Weight Reduction Percentage in Acid Resistance Test:

A sample (about 3 g) was placed on a watch glass and dried in an atmosphere of 70° C. until a constant weight (W1 [g]) is achieved. Then, 200 mL of an aqueous solution of sulfuric acid having a specific gravity at 20° C. of 1.3 g/cm³ is heated at 50° C. and the dried sample is immersed thereinto for 24 hours. After that, the sample is filtered through a filter, washed with water until pH of the filtrate becomes 7.0 and dried in an atmosphere of 70° C. until a constant weight (W2 [g]) is achieved. The weight reduction percentage in the acid resistance test is calculated by the following formula.

Weight reduction percentage(%)=(W1−W2)/W1×100

When a value of the above weight reduction percentage is small, it is believed that the fiber after the acid resistance test well retains a hydrophilic ingredient therein. It is therefore believed that a deterioration in a property hardly happens even if the fiber is repeatedly used as a battery. On the contrary, when the value of the weight reduction percentage is large, it is believed that the hydrophilic ingredient is decomposed and detached with a high probability whereby it is believed that the battery property gradually lowers upon the repeated use as the battery.

(3) Degree of Swelling in Water:

A dried sample (about 0.5 g) is immersed in pure water for 24 hours at 25° C. Then, the sample in a swollen state with water is sandwiched between filter papers to remove the water among the resins. A weight (W3 [g])) of the sample swollen as such is measured. Then, the sample is dried in a vacuum drier of 80° C. until a constant weight is achieved and a weight (W4 [g]) is measured. The degree of swelling in water is calculated according to the following formula using the above results.

Degree of swelling in water(g/g)=(W3−W4)/W4

(4) Measurement of Amount of Carboxyl Group:

A 1 mol/1 aqueous solution of hydrochloric acid is added to a sample dispersed in water to adjust the pH to 2 so that all of carboxyl groups contained in the sample are previously changed into H-type followed by well drying. About 1 g of the sample after the drying is precisely weighed [W5 [g]], 200 ml of water is added thereto and a titration curve is determined according to a conventional method using a 0.1 mol/ml aqueous solution of sodium hydroxide. An amount (V1 [ml]) of the aqueous solution of sodium hydroxide consumed by COOH is determined by the titration curve. Then, the total carboxyl group amount is calculated by the following formula.

Total carboxyl group amount [mmol/g]=0.1×V1/W5

(5) Measurement of Sucked-Up length of diluted sulfuric acid:

A carded web of a fiber is prepared according to a conventional method. Surface and back of the web are punched for two times alternately using a needle punch to prepare a needle-punched nonwoven fabric in a predetermined size (25 mm×200 mm). The measurement is conducted in accordance with a Byreck method for a water absorption test method for fiber products (JIS L 1907), except that diluted sulfuric acid (a specific gravity at 20° C.: 1.26) is used instead of water. A sucked-up height after 10 minutes from the immersion into diluted sulfuric acid is measured.

(6) Preparation of Lead Paste:

Minium (15 parts by weight), 4.3 parts by weight of an acrylonitrile-based fiber for electrodes according to the present invention and 140 parts by weight of diluted sulfuric acid (a specific gravity at 20° C.: 1.26) are placed into a kneading mixer to prepare a minium slurry. After that, the resulting minium slurry and 850 parts by weight of lead powder are placed in a paste kneader and kneaded with 200 parts by weight of water to prepare a paste of an active material for a positive electrode. A degree of forming granular lumps of the acrylonitrile-based fiber for electrodes upon preparation of the paste is evaluated by naked eye as “∘” (no granular lump), “Δ” (a few granular lumps) and “×” (many granular lumps).

### Example 1

An acrylonitrile-based polymer was prepared by subjecting 90 parts by weight of acrylonitrile, 9.7 parts by weight of methyl acrylate and 0.3 part by weight of sodium methallylsulfonate to a suspension polymerization. In addition, an acrylonitrile-based hydrophilic resin A was prepared by subjecting 27.5 parts by weight of acrylonitrile, 72.5 parts by weight of methoxypolyethylene glycol (30 mol) methacrylate to a suspension polymerization. A degree of swelling of the hydrophilic resin in water was 30 g/g.

A spinning dope was prepared by dissolving 97 parts by weight of the acrylonitrile-based polymer in 900 parts by weight of a 50% aqueous solution of sodium rhodanate and then by adding 3 parts by weight of the acrylonitrile-based hydrophilic resin A thereto and by mixing therewith. The spinning dope was spun followed by subjecting to each of steps of coagulation, washing with water and drawing whereupon an acrylonitrile-based fiber A of Example 1 was prepared. A volume resistivity of the acrylonitrile-based fiber was 0.07>10⁹ Ω·cm and a weight reduction percentage thereof in the acid resistance test was 0.38%.

### Example 2

Polyethylene glycol monomethyl ether (a number-average molecular weight: 750) (58 parts by weight) and 12 parts by weight of 2-methacryloyloxyethyl isocyanate were subjected to a synthesis in a nitrogen atmosphere in toluene at 60° C. to give a macromonomer. The resulting macromonomer was subjected to a suspension polymerization with 30 parts by weight of acrylonitrile to prepare an acrylonitrile-based hydrophilic resin B. A degree of swelling of the hydrophilic resin in water was 28 g/g.

The same operation as in Example 1 was conducted except that an acrylonitrile-based hydrophilic resin B was used instead of the acrylonitrile-based hydrophilic resin A to prepare an acrylonitrile-based fiber B of Example 2. A volume resistivity of the acrylonitrile-based fiber was 0.08×10⁹ Ω·cm.

### Example 3

Acrylonitrile (70 parts by weight) and 30 parts by weight of methoxypolyethylene glycol (30 mol) methacrylate were subjected to a suspension polymerization to prepare an acrylonitrile-based hydrophilic resin C. A degree of swelling of the hydrophilic resin in water was 20 g/g.

The same operation as in Example 1 was conducted except that an acrylonitrile-based hydrophilic resin C was used instead of the acrylonitrile-based hydrophilic resin A to prepare an acrylonitrile-based fiber C of Example 3. A volume resistivity of the acrylonitrile-based fiber was 0.18×10⁹ Ω·cm.

### Comparative Example 1

The same operation as in Example 1 was conducted except that acrylonitrile-based hydrophilic resin A was not added but only an acrylonitrile-based polymer was used whereupon an acrylonitrile-based fiber D was prepared. A volume resistivity of the acrylonitrile-based fiber was 10×10⁹ Ω·cm.

### Comparative Example 2

Acrylonitrile (5 parts by weight) and 95 parts by weight of methoxypolyethylene glycol (30 mol) methacrylate were subjected to a suspension polymerization to prepare an acrylonitrile-based hydrophilic resin D. It was attempted to prepare a fiber by the same operation as in Example 1 except that the acrylonitrile-based hydrophilic resin D was used instead of the acrylonitrile-based hydrophilic resin A. However, an affinity for the acrylonitrile-based polymer became low. As a result, a clogging of nozzle and yarn breakage frequently happened during the spinning step whereby no aimed fiber was obtained.

### Comparative Example 3

Acrylic acid was subjected to a graft polymerization to a fiber consisting of polypropylene to give an acrylic acid-grafted polypropylene fiber. A degree of the graft polymerization of acrylic acid to a weight of the fiber after the graft polymerization was 47% by weight. A volume resistivity was 3×10⁹ Ω·cm. A weight reduction percentage in an acid resistance test was 6.1%. Amounts of carboxyl group in the fiber before and after the acid resistance test were measured. The amount before the test was 6.53 mmol/g while the amount after the test was 5.49 mmol/g.

### Example 4

The acrylonitrile-based fiber A obtained by the method of Example 1 (a fineness: 3.3 detx; a fiber length: 51 mm) (60%) was blended with hot-melt polyester (Melty (registered trade mark) 4080 manufactured by Unitika; a fineness: 4.4 dtex; a fiber length: 51 mm) (40%), and a needle-punched nonwoven fabric A (a basis weight: 280 g/m²; a thickness: 2.0 mm) was prepared by the above-mentioned method. A sucked-up length of diluted sulfuric acid by the nonwoven fabric A was 53 mm.

### Comparative Example 4

The acrylonitrile-based fiber D obtained by the method of Comparative Example 1 (a fineness: 3.3 detx; a fiber length: 51 mm) (60%) was blended with hot-melt polyester (Melty (registered trade mark) 4080 manufactured by Unitika; a fineness: 4.4 dtex; a fiber length: 51 mm) (40%), and a needle-punched nonwoven fabric B (a basis weight: 275 g/m²; a thickness: 1.9 mm) was prepared by the above-mentioned method. A sucked-up length of diluted sulfuric acid by the nonwoven fabric B was 28 mm.

### Referential Example 1

Only hot-melt polyester (Melty (registered trade mark) 4080 manufactured by Unitika; a fineness: 4.4 dtex; a fiber length: 51 mm) was used, and a needle-punched nonwoven fabric C (a basis weight: 330 g/m²; a thickness: 2.25 mm) was prepared by the above-mentioned method. A sucked-up length of diluted sulfuric acid by the nonwoven fabric C was 2 mm.

In Examples 1 to 3, the volume resistivity was good. In the meantime, in Comparative Example 1, no hydrophilic ingredient was contained therein whereby the volume resistivity was very high. This may be a reason why the sucked-up length of diluted sulfuric acid by the nonwoven fabric B prepared by using the acrylonitrile-based fiber D of Comparative Example 1 became as low as 28 mm while the sucked-up length of diluted sulfuric acid by the nonwoven fabric A prepared by using the acrylonitrile-based fiber A of Example 1 was 53 mm.

The nonwoven fabric prepared by using the acrylonitrile-based fiber of the present invention shows a good result in the sucked-up length of diluted sulfuric acid. It is likely that, when the fiber as such is dispersed into an active substance layer to prepare an electrode, the wetting ability of the electrode becomes high and the active substance even in an inner area of the electrode can be efficiently utilized whereby the battery capacity is enhanced.

Further, in Example 1 wherein the hydrophilic ingredient is contained in an inner area of the fiber, there is achieved a good weight reduction percentage in the acid resistance test. In view of the above, a deterioration of the electrode is suppressed and a long life of the battery can be expected when the fiber is used in an electrode for a lead-acid battery. On the contrary, in Comparative Example 3 wherein acrylic acid is subjected to a graft polymerization with the polypropylene fiber, the weight reduction percentage in the acid resistance test is more than that in Example 1 and, moreover, the amount of carboxylic group which is a hydrophilic group decreases before and after the measurement. In view of the above, it is likely in Comparative Example 3 that a graft layer of acrylic acid formed on a surface of the polypropylene fiber is predominantly decomposed and eluted by its contact with an acid.

### Example 5

Spinning conditions were modified in the method of Example 1 whereupon six types of acrylonitrile-based fibers for electrodes having different finenesses and cut lengths were prepared. The resulting fibers were used to prepare the above-mentioned lead pastes and the evaluation was conducted for the degree of being apt to give granular lumps. The result is shown in Table 1.

TABLE 1

| | Fineness | Cut lengths | Aspect | Degree of being apt to |
|---|---|---|---|---|
| | (dtex) | (mm) | ratio | give granular lumps |
| Example 5 | 0.7 | 2 | 229 | ∘ |
| | | 3 | 343 | Δ |
| | 1.0 | 2 | 191 | ∘ |
| | | 3 | 287 | Δ |
| | 3.3 | 2 | 105 | ∘ |
| | | 3 | 158 | ∘ |

When the acrylonitrile-based fiber for electrodes in accordance with the present invention is used, the fiber rarely becomes granular lumps in the preparation of a paste whereby the fiber can be homogeneously dispersed into the lead paste. Especially, when the aspect ratio is not less than 1 and less than 250, very good results were achieved. It is therefore likely that, in the electrode prepared by using the paste, the wetting ability of the electrode becomes high and the active substance even in the inner area of the electrode can be efficiently utilized whereby the battery capacity is improved.

In the acrylonitrile-based fiber for electrode according to the present invention, the hydrophilic ingredient is contained in the inner area of the fiber whereby the volume resistivity and the weight reduction percentage in the acid resistance test showed good values. Moreover, as a result of the fact that the hydrophilic ingredient is contained in the inner area of the fiber, hydrophilicity of the fiber is enhanced. Accordingly, as will be apparent from the result of the measurement of the sucked-up length of diluted sulfuric acid, the nonwoven fabric prepared by using the fiber containing the hydrophilic ingredient is now capable of positively absorbing the diluted sulfuric acid. It is likely that, in an electrode prepared by dispersing the fiber as such in an active substance layer, the wetting ability is improved and the active substance even in the inner area of the electrode can be efficiently utilized whereby the battery capacity is enhanced. Consequently, the acrylonitrile-based fiber for electrodes in accordance with the present invention can be advantageously utilized for the electrodes in a lead-acid battery, etc.

1. An acrylonitrile-based fiber for electrodes which contains a hydrophilic ingredient in an inner area of the fiber and has a volume resistivity of not more than 1×10⁹ Ω·cm.

2. The acrylonitrile-based fiber for electrodes according to claim 1, wherein its aspect ratio is not less than 1 and less than 250.

3. The acrylonitrile-based fiber for electrodes according to claim 1, wherein the hydrophilic ingredient is a polymer containing, as a constituting unit, 30 to 90% by weight of a monomer represented by the following formula. 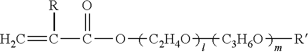
(In the formula, R is hydrogen atom or lower alkyl group; R′ is hydrogen atom, alkyl group having 18 or less carbon(s), phenyl group or a derivative thereof; 15<I<50; and 0≦m<I.)

4. The acrylonitrile-based fiber for electrodes according to claim 1, wherein the hydrophilic ingredient is a polymer containing, as a constituting unit, 10 to 70% by weight of acrylonitrile.

5. An electrode containing the fiber according to claim 1.

6. A lead-acid battery having the electrode according to claim 5.
